(19) United States
(12) Patent Application Publication
(10) Pub. No.: US 2026/0274158 A1
(43) Pub. Date: Sep. 17, 2026

(54) SIGNALING DEVICE FOR VEHICLES UNDER EMERGENCY CONDITIONS

(71) Applicant: IP CAPITAL FUND S.C.A., Luxembourg (LU)

(72) Inventor: Fabio LETTIERI, Luxembourg (LU)

(73) Assignee: IP CAPITAL FUND S.C.A., Luxembourg (LU)

(21) Appl. No.: 19/470,041

(22) PCT Filed: Mar. 26, 2024
(86) PCT No.: PCT/IB2024/052879

§ 371 Date: Sep. 27, 2025

(30) Foreign Application Priority Data
Mar. 28, 2023 (IT) 102023000005886

(51) Int. Cl. B60Q 1/52; B60Q 1/26

(52) U.S. Cl. CPC B60Q 1/52; B60Q 1/2611; B60Q 1/2615; B60Q 1/2692; B60Q 2400/50

(57) ABSTRACT

A signaling device for vehicles under emergency conditions comprising a basic structure; an attachment device/component/unit/element/apparatus or the like (e.g., a magnet) for attaching the basic structure to a canopy of a vehicle; a signaling assembly for signaling the presence of the vehicle to coming vehicles associated with the basic structure; a lighted device adapted to switch on; a projection device/component/unit/element/apparatus or the like (e.g., a projector) adapted to project at least one emergency signal to a predefined distance from the vehicle.

### TECHNICAL FIELD

The present invention relates to a signaling device for vehicles under emergency conditions.

### BACKGROUND ART

It is well known how the Highway Code requires the use of the warning triangle to signal the presence of a stationary vehicle on the roadway.

Under emergency situations such as the breakdown of the vehicle in which you are traveling or in the event of an accident, the regulations require you to stop outside the roadway, signaling the stationary vehicle by placing the appropriate warning triangle on the ground about 50 m from the vehicle.

Placement of the warning triangle is done by the driver or a passenger in the stationary vehicle who, wearing the appropriate reflective vest, gets out of the vehicle and places it at an appropriate distance.

The aforementioned operations must be carried out safely, that is, paying attention to the oncoming vehicles and making sure that the stationary vehicle does not pose an obstacle to the transit of the other vehicles.

Added to this is the fact that the stationary vehicle, as well as those performing the warning triangle placement operations, must be made visible; this means that the vehicle must stop away from the roadway, in case of reduced visibility with its headlights and/or four blinkers on, so as to be easily identifiable by other vehicles approaching and not be the cause of further damage to other vehicles and/or people.

However, it is easy to appreciate how these operations are not always possible; in fact, in the case of narrow roadways that do not have special lanes and/or parking areas, one is forced to stop at the edge of the roadway or, even in the areas used for normal traffic, forcing those performing the warning triangle placement operations to move between oncoming vehicles, exposing themselves to the risk of being run over and/or themselves becoming the cause of an accident between other vehicles.

This risk increases even more in the case of dimly lit streets, where those performing the above operations are forced to move in the dark.

To solve at least some of these drawbacks, warning devices of the type of lighted sirens to be attached to the roof of the stationary vehicle are known and increasingly popular.

Such devices, known as “V16”, make it possible to greatly reduce the risks related to the use of the warning triangle since their use does not require getting out of the vehicle; it is, in fact, sufficient for the user to extend his or her arm out of the window and apply the devices in question on the roof to signal an emergency while remaining safely inside the vehicle.

In other words, the use of these devices makes it possible to signal the condition of emergency without forcing the user to put himself in potentially dangerous situations and without the user themselves becoming the cause of possible accidents for oncoming vehicles.

That said, the need to improve the signaling devices just described is particularly felt to date, enabling vehicles to identify a stationary vehicle even more quickly and easily and, thanks to this prerogative, lowering the risk of accidents dramatically.

### DESCRIPTION OF THE INVENTION

The main aim of the present invention is to devise a signaling device for vehicles under emergency conditions which allows greatly improving the visibility of a stationary vehicle and, therefore, the identification of the latter by oncoming vehicles compared with what is possible to date by means of the prior art mentioned above.

Within that main aim, one object of the present invention is to devise a signaling device for vehicles under emergency conditions which is very versatile in its use and which can be employed with equal profit both in the case of vehicles stopped along straight stretches of road and in the case of vehicles stopped on curves. Another object of the present invention is to devise a signaling device for vehicles under emergency conditions which can be controlled remotely by the user in an easy and functional manner, thus allowing the user to remain inside the vehicle at all times.

Another object of the present invention is to devise a signaling device for vehicles under emergency conditions which can overcome the aforementioned drawbacks of the prior art within the framework of a simple, rational, easy and efficient to use as well as cost-effective solution.

The above objects are achieved by this signaling device for vehicles under emergency conditions having the characteristics of claim 1.

### BRIEF DESCRIPTION OF THE DRAWINGS

Other characteristics and advantages of the present invention will become more apparent from the description of a preferred, but not exclusive, embodiment of a signaling device for vehicles under emergency conditions, illustrated by way of an indicative, yet non-limiting example, in the accompanying tables of drawings in which:

FIGS. 1 and 2 are axonometric overall views of the device according to the invention in two different configurations;

FIG. 3 is an exploded view of the device according to the invention;

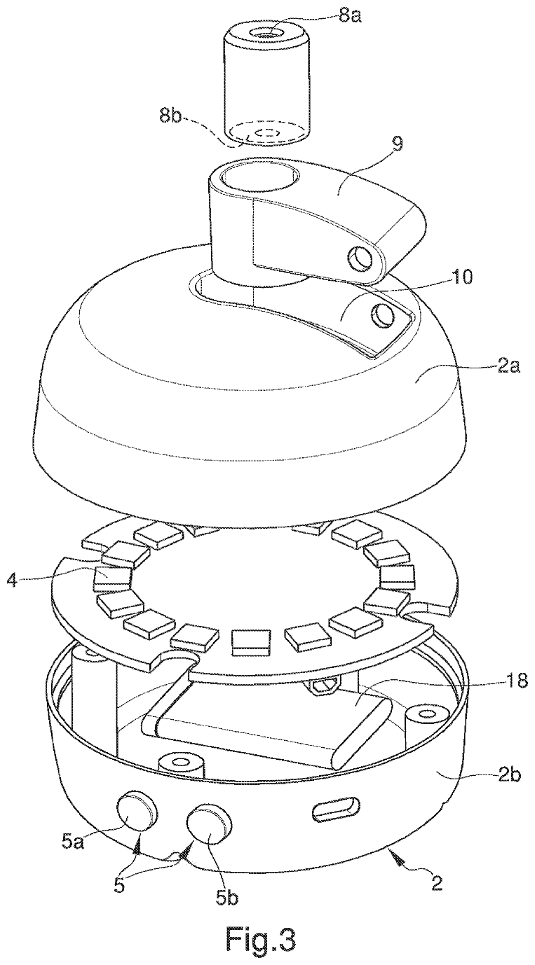

FIG. 4 is a schematic representation of some components of the device according to the invention;

FIG. 5 shows, by way of an example, a possible use of the device according to the invention.

### EMBODIMENTS OF THE INVENTION

With particular reference to these figures, reference numeral 1 globally denotes a signaling device for vehicles under emergency conditions.

First of all, the signaling device 1 for vehicles under emergency conditions comprises at least a basic structure 2 and attachment means 3 for attaching the basic structure 2 to a canopy T of a vehicle V (e.g., a motor vehicle).

Specifically, the basic structure 2 comprises a first half-shell 2a and a second half-shell 2b mutually coupled.

Going into detail, the first half-shell 2a preferably has a substantially hemispherical conformation.

Again, the first half-shell 2a is made at least partly transparent.

As for the second half-shell 2b, it preferably has a cylindrical conformation. The two half-shells 2a, 2b are coupled by interlocking, but the possibility that they may be coupled differently cannot be ruled out, such as by the interposition of threaded means (e.g., screws or the like) or other means of connection known to the branch engineer.

Advantageously, the attachment means 3 are associated with the second half-shell 2b.

More specifically, the attachment means 3 are associated with the base of the second half-shell 2b, that is, with the lower portion corresponding to one face of the aforementioned cylinder.

In this regard, the attachment means 3 preferably comprise at least one magnetic element 3 adapted to couple to the canopy T in a removable manner.

The magnetic coupling ensures firm attachment of the device 1 to the vehicle V, thus ensuring that any gusts of wind will not displace or even remove the device itself from the canopy T.

At the same time, the presence of the magnetic element 3 allows the user to remove the device 1 from the canopy T without excessive effort, thus combining remarkable reliability with appreciable ease of use.

The device 1 then comprises at least one signaling assembly 4, 6 for signaling the presence of the vehicle V to oncoming vehicles.

Specifically, the signaling assembly 4, 6 is associated with the basic structure 2 and comprises at least one lighted device 4 adapted to switch on.

Preferably, the lighted device 4 is configured to emit a yellow-colored light.

For this purpose, the lighted device 4 may, e.g., comprises one or more white LEDs and a yellow filter, or it may comprise one or more yellow LEDs and be without the filter.

Again, the lighted device 4 is further configured to flash at a predetermined frequency.

Specifically, the preset frequency is of between 0.8 Hz and 2.0 Hz. In addition, the lighted device 4 is adapted to produce light intensity of between 40 and 80 cd in the horizontal direction and at least 25 cd in the vertical direction.

Conveniently, the lighted device 4 is also adapted to emit light in such a way that it is visible in any horizontal direction (i.e., 360°) and at an angle of ±8° with respect to a horizontal plane.

Conveniently, the device 1 comprises on/off means 5 associated with the signaling assembly 4, 6 and adapted to allow enabling/disabling the latter.

In the present case, the on/off means 5 comprise at least a first on/off element 5a associated with the lighted device 4 for switching the latter on/off.

Specifically, the first on/off element 5a is of the type of a push-button.

This allows the user to press the first on/off element 5a to turn the lighted device 4 on and off, that is, to cause it to emit light or stop emitting light.

According to the invention, the signaling assembly 4, 6 comprises projection means 6 adapted to project at least one emergency signal S to a predefined distance from the vehicle V.

It is useful to point out that, in the context of this disclosure, the term “emergency signal” means the projection of an image preferably, but not exclusively, representing a red-colored warning triangle similar to the usual warning triangles with which, in accordance with the Highway Code, each vehicle is provided.

That being said, having projection means 6 proves to be a rather important technical expedient to improve the detectability of the stationary vehicle V, thus significantly reducing the risk of it or its passengers becoming the cause of accidents or being involved in accidents themselves.

In particular, the fact of remotely projecting the emergency signal 6 allows oncoming vehicles to be warned in time of the presence of a stationary vehicle V, enabling them to take the necessary precautions to avoid giving rise to traffic accidents.

Preferably, the projection means 6 are associated with the first half-shell 2a.

In order to ensure the proper projection of the emergency signal S, the device 1 may comprise a focusing unit 7 operationally connected to the projection means 6 and adapted to maintain the focus with which the emergency signal S is projected unchanged over time.

Going into detail, the projection means 6 comprise at least one projection element 8a, 8b of laser light and/or led light.

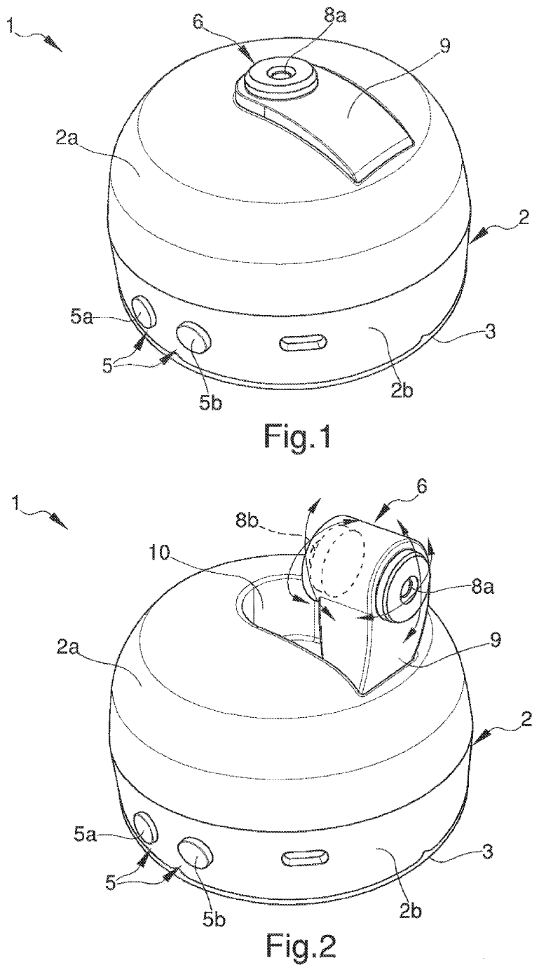

As visible by comparing FIGS. 1 and 2, the projection means 6 are associated with the basic structure 2 in a movable manner between a configuration of switching on, wherein the projection element 8a, 8b is arranged protruding from the basic structure 2 and projects the emergency signal 6, and a configuration of switching off, wherein the projection element 8a, 8b is retracted into the basic structure 2 and interrupts the projection of the emergency signal 6.

In this regard, the projection means 6 comprise at least one supporting arm 9 adapted to support the projection element 8a, 8b and associated with the basic structure 2 in a manner which is rotatable between the configuration of switching on, wherein it is arranged substantially vertically, and the configuration of switching off, wherein it is arranged substantially horizontally.

Specifically, the supporting arm 9 is hinged to the basic structure 2.

More specifically, the supporting arm 9 is hinged to the first half-shell 2a.

In this regard, the first half-shell 2a defines a housing 10 of the projection means 6 adapted to contain the latter in the configuration of switching off.

In detail, the projection means 6 are pop-up extracted from the housing 10 in the transition from the configuration of switching off to the configuration of switching on, while they are retracted in the housing 10 in the transition from the configuration of switching on to the configuration of switching off.

Thus, the housing 10 allows the overall dimensions of the device 1 to be minimized when the projection means 6 are in the configuration of switching off, thus increasing the ease of transport of the device itself.

Conveniently, the on/off means 5 comprise at least a second on/off element 5b associated with the projection means 6 and configured to arrange the latter in the configuration of switching on and in the configuration of switching off.

Specifically, the second on/off element 5b is of the type of a push-button.

This allows the user to press the second on/off element 5b to cause the projection element 8a, 8b to start or stop the projection of the emergency signal S.

In combination with or in place of the second on/off element 5b, automatic activation means of the projection means 6 can be provided which are configured to automatically activate/deactivate the projection element 8a, 8b (i.e., to activate/deactivate the projection of the emergency signal S) if the supporting arm 9 is arranged in a vertical/horizontal position.

Therefore, in this case, it is sufficient to manually raise the supporting arm 9 to activate the projection of the emergency signal S by the projection element 8a, 8b.

Similarly, it is sufficient to manually lower the supporting arm 9 to deactivate the projection of the emergency signal S by the projection element 8a, 8b.

Conveniently, the signaling assembly 4, 6 comprises directing means 11a, 11b of the projection means 6 associated with the basic structure 2.

Specifically, the directing means 11a, 11b comprise a motorized element 11a, 11b aimed at enabling the direction of the projection means 6 depending on the conformation of the road on which the vehicle V stopped and/or on the environmental conditions surrounding the device 1.

The motorized element 11a, 11b ensures that the distance and direction of the emergency signal S can be varied allowing, against any road conformation and/or environmental conditions, the remote visibility of the emergency signal itself. To further improve the visibility of the vehicle V, the projection means 6 preferably comprise at least a first projection element 8a and at least a second projection element 8b adapted to project the emergency signal 6 in the front direction and in the rear direction of vehicle V, respectively.

The projection elements 8a, 8b are both mounted on the supporting arm 9; therefore, in the transition from the configuration of switching off to the configuration of switching on both projection elements 8a, 8b are activated, and likewise, in the transition from the configuration of switching on to the configuration of switching off both projection elements 8a, 8b are deactivated. The possibility cannot however be ruled out of providing two supporting arms 9, one for each projection element 8a, 8b.

Conveniently, the directing means 11a, 11b comprise first directing means 11a of the first projection element 8a and second directing means 11b of the second projection element 8b.

In more detail, the first directing means 11a comprise a first motorized element 11a aimed at enabling the direction of the first projection element 8a, while the second directing means 11b comprise a second motorized element 11b aimed at enabling the direction of the second projection element 8b.

Specifically, the directing means 11a, 11b are individually and independently adjustable from each other.

This means that the orientation of the first projection element 8a and, therefore, of the emergency signal S projected thereby can be made different from that of the second projection element 8b and, consequently, of the emergency signal S projected thereby.

This prerogative allows the projection of the emergency signals 6 to be even more precisely adapted to the special conformation of the road, thus enabling effective identification of the vehicle V both along straight and curved road sections.

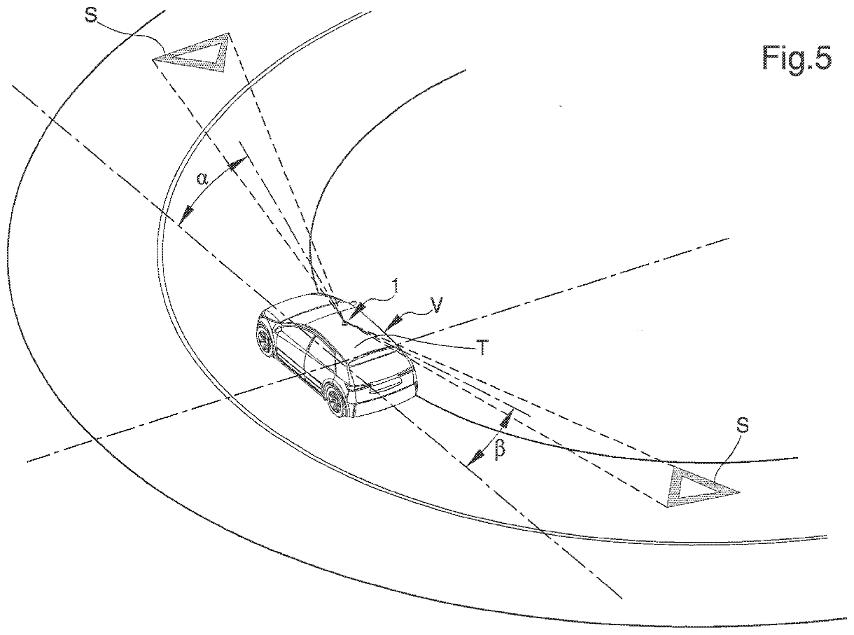

In the first case, in fact, it is sufficient for the emergency signals 6 to be projected substantially aligned, while in the second case it is possible to angle one or both of the emergency signals 6 by going along with the specific conformation of the road (see in this regard FIG. 5, where the two emergency signals S are projected by the device 1 with two different angles α and β).

Advantageously, the device 1 comprises at least one electronic unit 12 operationally associated with the signaling assembly 4, 6 and configured to control the operation of the projection means 6 and/or of the directing means 11a, 11b.

Preferably, the electronic unit 12 is configured to control the operation of both projection means 6 and directing means 11a, 11b.

The electronic unit 12 is therefore configured to operate on the projection means 6 and on the directing means 11a, 11b in a fully automatic manner.

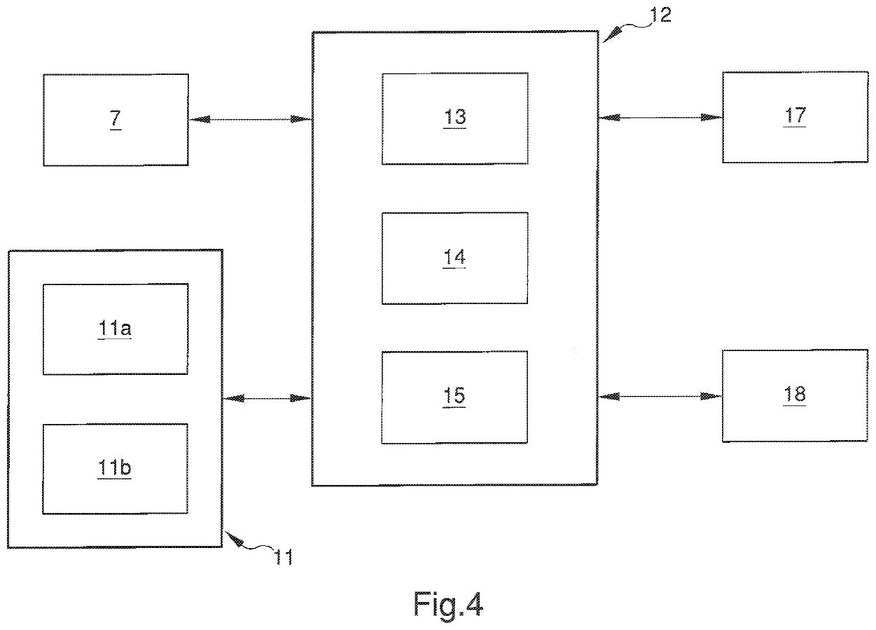

In this regard, as visible in FIG. 4, the electronic unit 12 comprises:
at least a first control module 13 associated with the projection means 6 and configured to command the transition of the latter from the configuration of switching off to the configuration of switching on and vice versa; and
at least a second control module 14 operationally associated with the directing means 11a, 11b.

Conveniently, the electronic unit 12 comprises at least one remote connecting module 15 to at least one electronic device accessible to a user.

In this regard, the electronic device can be of the type of a smartphone, a tablet, a computer and so on.

Specifically, the connecting module 15 performs its function through wireless technology, such as through Wi-Fi, Bluetooth, Lo-Ra or similar remote communication protocols.

This particular expedient allows the user to control the control modules 13, 14 and, therefore, the projection means 6 and the directing means 11a, 11b while remaining inside the vehicle; in other words, not having to get out of the vehicle, the user can activate and deactivate the projection of the emergency signals S and/or to adjust the position of the projection points of the latter easily, intuitively, and without having to put themselves in potentially dangerous situations.

It is easy, then, to appreciate how this expedient concurs synergistically with what has been described so far in creating a device 1 which is able to ensure a high rate of safety for the passengers in the stationary vehicle V.

Conveniently, the device 1 comprises capturing means 16 of images operationally connected to the electronic unit 12 and adapted to capture images of the outer space surrounding the device 1 for the adjustment of the directing means 11a, 11b.

In the present case, the capturing means 16 comprise one or more cameras adapted to allow viewing of the area surrounding the vehicle V.

More specifically, the capturing means 16 comprise at least a first camera adapted to allow the view of the front area to the vehicle V and at least a second camera adapted to allow the view of the rear area to the vehicle V.

In this way, it is possible to easily locate the projection points of the emergency signals S, possibly adjusting their position by means of the respective directing means 11a, 11b.

Conveniently, the device 1 comprises detecting means 17 for detecting the geo-location coordinates of the device itself.

Specifically, the geo-location coordinates are of the type of GPS coordinates.

The detecting means 17 enable prompt identification of the position of the stationary vehicle V and, therefore, rapid rescue intervention in case the vehicle itself is under an emergency situation, such as if it has broken down or suffered an accident.

Still, the device 1 preferably comprises at least one internal power supply unit 18 of the type of a battery.

Specifically, the internal power supply unit 18 consists of either replaceable batteries, e.g., of the stylus type, or batteries rechargeable by means of an electrical device not shown in the figures.

In the latter case, in order to be recharged, the batteries must be taken out of the device 1 and connected to the electrical device, which is specially connected to the power grid by connection to an available power outlet.

Once sufficient time has waited for the charging process to complete, the batteries can be reinserted into the device 1 and the latter can therefore resume operation. Alternatively, the batteries can be recharged without even taking them out of the device 1; in this case, the device 1 may comprise a connection port to which an electrical power cord can be connected, if necessary, similar to what happens with standard mobile phones.

Such a connection port may be of the type of a USB, such as a USB-C, or of different types known to the industry expert that would, in any case, allow fast and efficient charging of the internal power supply unit 18.

It has in practice been ascertained that the described invention achieves the intended objects.

In particular, the fact is emphasized that the special expedient of providing projection means that can be activated to project an emergency signal makes it possible to greatly increase the visibility of the stationary vehicle, cooperating synergistically with the light device in dramatically lowering the possibility of both being involved in accidents and causing them.

In addition, the special expedient of providing directing means of the projection means allows the projection elements to be oriented independently and, therefore, to signal the presence of the stationary vehicle with the same profit whether the latter is along straight stretches of road or on curves.

In the former case, in fact, it is sufficient to project the emergency signals by arranging them in a substantially aligned configuration, while in the latter case it is possible to angle one or both emergency signals with respect to the aligned configuration and go along with the specific road conformation.

Finally, the fact is emphasized that providing a remote connection module to an electronic device accessible by a user allows the latter to control the directing means while remaining inside the vehicle.

It is easy to appreciate how this technical expedient concurs with what has been described so far in making the use of the signaling device in question even more effective in signaling the presence of a stationary vehicle to the oncoming vehicles and thereby increasing the safety of the passengers of those vehicles.

1) A signaling device (for vehicles under emergency conditions, the signaling device comprising:
at least one basic structure;
attachment means for attaching said at least one basic structure to a canopy of a vehicle; and
at least one signaling assembly for signaling a presence of said vehicle to coming vehicles associated with said at least one basic structure and including at least one lighted device adapted to switch on; wherein
said signaling assembly comprises projection means adapted to project at least one emergency signal to a predefined distance from said vehicle.

2) The signaling device according to claim 1, wherein said projection means comprise at least one projection element of laser light and/or led light.

3) The signaling device according to claim 2, wherein said projection means are associated with said at least one in a movable manner between a configuration of switching on, wherein said projection element is arranged protruding from said basic structure and projects said emergency signal, and a configuration of switching off, wherein said projection element is retracted into said at least one basic structure and interrupts the projection of said emergency signal.

4) The signaling device according to claim 3, wherein said projection means comprise at least one supporting arm adapted to support said projection element and associated with said at least one basic structure in a manner which is rotatable between said configuration of switching on, wherein it is arranged substantially vertically, and said configuration of switching off, wherein it is arranged substantially horizontally.

5) The signaling device according to claim 1, wherein said signaling assembly comprises directing means of said projection means associated with said at least one basic structure.

6) The signaling device according to claim 5, wherein
said projection means comprise at least a first projection element and at least a second projection element adapted to project said emergency signal in a front direction and in a rear direction respectively to said vehicle; and
said directing means comprise first directing means of said first projection element and second directing means of said second projection element, wherein said directing means are individually and independently adjustable from each other.

7) The signaling device according to claim 6, further comprising: at least one electronic unit operationally associated with said signaling assembly and configured to control the operation of said projection means and/or of said directing means.

8) The signaling device according to claim 7, wherein said electronic unit comprises:
at least a first control module associated with said projection means and configured to command the switching of the latter from said configuration of switching off to said configuration of switching on and vice versa; and
at least a second control module operationally associated with said directing means.

9) The signaling device according to claim 8, wherein said electronic unit comprises at least one remote connecting module to at least one electronic device accessible by a user.

10) The signaling device according to claim 7, further comprising: image capturing means operationally connected to said electronic unit and adapted to capture images of the outer space surrounding said signaling device for the adjustment of said directing means.

11) The signaling device according to claim 1, wherein said attachment means comprise at least one magnetic element adapted to couple to said canopy in a removable manner.

12) The signaling device according to claim 1, further comprising: detecting means for detecting the geo-location coordinates of said device.

13) The signaling device according to claim 1, further comprising: at least one internal power supply unit of the type of a battery.

14) A signaling device comprising:
at least one basic structure;
a magnet configured to attach said at least one basic structure to a canopy of a vehicle; and
at least one signaling assembly for signaling a presence of said vehicle to coming vehicles associated with said at least one basic structure and including at least one lighted device adapted to switch on, wherein
said signaling assembly comprises a projector adapted to project at least one emergency signal to a predefined distance from said vehicle.

15) The signaling device according to claim 14, wherein
said projector comprises at least one projection element of laser light and/or led light,
said projector is associated with said at least one basic structure in a movable manner between a configuration of switching on, wherein said projection element is arranged protruding from said at least one basic structure and projects said emergency signal, and a configuration of switching off, wherein said projection element is retracted into said at least one basic structure and interrupts the projection of said emergency signal, and
said projector comprises at least one supporting arm adapted to support said projection element and associated with said at least one basic structure in a manner which is rotatable between said configuration of switching on, wherein said projector is arranged substantially vertically, and said configuration of switching off, wherein projector is arranged substantially horizontally.
